(19) United States
(12) Patent Application Publication
(10) Pub. No.: US 2005/0115071 A1
(43) Pub. Date: Jun. 2, 2005

(54) Manufacturing for face gears

(76) Inventor: Yakov Fleytman, Lake Orion, MI (US)

Correspondence Address: YAKOV FLEYTMAN, 3233 HICKORY DRIVE, LAKE ORION, MI, 48359, US

(21) Appl. No.: 10/725,676

(22) Filed: Dec. 2, 2003

(51) Int. Cl. B21K 1/30; B23P 15/14

(52) U.S. Cl. 29/893.32; 29/893.35

(57) ABSTRACT

Enveloping worm face gears are machined with plunge feeding. Machining could be done by hobbing or cold rolling. This reduces production cost and makes manufacturing easier.

### FIELD OF THE INVENTION

The present invention relates to production of an enveloping worm face gears. They are used to reduce or to increase speed or increase or reduce torque in helicopter or automobile gearboxes, turbine gearboxes, ship's transmission, and industrial applications. Certain applications may be outside of these fields, like power windows, doors or seats, power steering systems, chainless bicycle or motorcycle transmissions, and much more.

### BACKGROUND OF THE INVENTION

A right angle gear transmission is well known for the transformation of motion and power between shafts where the axes of the pinion and the gear may be crossed or intersected. Recently two new types of enveloping worm gear transmissions from my U.S. Pat. No. 6,148,683 and enveloping worm face transmission from my patent application Ser. No. 10/435,143 made right angle gear transmission more attractive for use in many applications, even in applications where it was traditional to use parallel shaft gears. These gears are able to transfer mechanical power between crossed or intersected shafts more efficiently.

New technology lowers production cost of spiral bevel and hypoid gears, but to make face gear and especially enveloping pinion, more machining time is still required. Known enveloping worms have long threads with one or more than one of thread revolutions. This creates problems for manufacturing. In the Cone patent (U.S. Pat. No. 1,885,686) generation of an enveloping worm is made by relative rotation of a hob and worm blank in predetermined time relation on axes perpendicular to each other. Cutting tool is thin to avoid undesirable cuts of enveloping threads. During hobbing the distance between axes of the hob and the wheel blank changes and after completed feeding the hob widens the gaps by additional angular displacement to generate sides of thread surfaces. It is a low speed production technology. In the Trbojevich patent (U.S. Pat. No. 1,987,877) generation of an enveloping worm is made by reciprocating a tool with helical cutting teeth in a helical path, placing the axis of the enveloping worm blank to be cut tangentially or transversely of the cutter path. This is also a low speed production technology. In patents by Wildhaber (U.S. Pat. No. 1,902,683 and U.S. Pat., No. 2,935,888 and U.S. Pat. No. 3,079,808) thin worm hob with variable orientation and feeding is able to generate surfaces sides of threads. Worm gear has composite tooth surfaces in order to be able to conjugate with an enveloping pinion. When Wildhaber worm is engaged with worm gear in standard enveloping worm and worm gear transmission, it produces reliable contact pattern only in one direction of rotation by concave side of threads. Convex side of threads is useless.

Stritzel U.S. Pat. No. 4,926,712 used plunging for machining hourglass (enveloping) gear, not enveloping worm. In his method, the rotating hob is fed in a radial direction towards the axis of the rotating blank. An enveloping gear has a very different profile compared to an enveloping worm or a face gear in enveloping face gear transmission. Even though it has an enveloping shape, the teeth are straight or helical. Enveloping worm threads are not similar to helical. These threads form an envelope and also have a twisted cross section along a thread. Face gear teeth of enveloping face transmission have very complicated surfaces, which are defined by mating with enveloping worm thread.

In U.S. Pat. No. 5,829,305 by A Cralg et al. uses rolling technology for enveloping pinion with plurality of teeth being substantially uniform in profile and substantially parallel to each other. They have an overall profile substantially non-uniform with reference to a longitudinal axis of a drive shaft. That is why they have a pitch between a first pair of said teeth that is different than a second pitch between a second pair of said teeth. In motion these gears do not have dynamic conjugacy action and is able to transfer a very limited amount of torque where for one direction of rotation they can transfer very small torque.

In another U.S. Pat. No. 6,247,376 by Zhou et al. an enveloping worm tooth thickness, radial tooth position and axial tooth position are varied in order to achieve equal worm gear index angles. Roll die has a profile of spur gear. Produced worm and worm gears also do not have dynamic conjugacy action and are able to transfer very limited torque.

Face gear of enveloping face gear is a very new invention and no information exists on how to make it in production, especially in mass production.

It was not useful to use plunging feeding by rotating tool to manufacture an enveloping worm for power transmission. New unique enveloping worm face gears have very short threads of enveloping worm that allowed very good contact pattern with mating face gear. That is why machining of this special enveloping pinion by using plunging feed became practical. Rotating tool for plunging of face gear for enveloping face transmission did not exist before.

### SUMMARY OF THE INVENTION

Right angle gears have very wide use in many applications. Right angle gears for the same size of the pinion and the same ratio have almost 50 percent more torque capacity than traditional parallel shaft gearings. This is primarily due to high contact ratio. In existing enveloping worm and worm gear transmission it was not possible to use plunge feeding because gears became just index drives and were not efficient gears for transmission power. In face enveloping worm gear transmissions pinions have less than one revolution of threads or even less than 180 degree of threads revolution. This makes enveloping worm pinion more similar to straight worm and allows the use of very productive technology that was developed for standard worm gears. The more expensive cost of production of enveloping worms can thus be reduced.

In new unique enveloping worm face gears profile of the enveloping pinion generates profile of mating face gear. Generated plunge feeding by hobbing or rolling, enveloping pinion teeth profile does not affect performance of the gears. Enveloping worm face gears have relative rotational motion with large area of contact. Enveloping worm thread has contact pattern of motion along the tooth: from the left to the right or from the right to the left depending on the direction of rotation. This also makes using plunge (radial) feeding for production of face gear very productive. In spiral bevel or hypoid gears pinion threads have contact pattern of motion across the tooth: from the top to the bottom. This makes plunge rolling for accurate tooth forming impossible.

Further areas of applicability of the present invention will become apparent from the detailed description provided hereinafter. It should be understood however that the complete description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the comprehensive description and the accompanying drawings, wherein:

FIG. 1 is an isometric view of an enveloping face gears with enveloping worm having threads with less than one revolution.

FIG. 2 is an isometric view of enveloping pinion having threads with less than one revolution.

FIG. 3 is an isometric view of a face gear.

FIG. 4 is an isometric view of enveloping worm blank in mesh with rotating hob having helical form.

FIG. 5 is a front view of enveloping worm blank in mesh with rotating hob having helical form.

FIG. 6 is an isometric view of enveloping worm blank in mesh with rotating hob having helical form, where enveloping blank is shortened for use as an enveloping worm pinion.

FIG. 7 is a front view of enveloping worm blank in mesh with rotating hob having helical form, where enveloping blank is shortened for use as an enveloping worm pinion. Position of rotating tool is for preliminary feeding.

FIG. 8 is an isometric view of a taped disc hob in mesh with an enveloping blank for machining one enveloping worm pinion.

FIG. 9 is a front view of a taped disc hob in mesh with an enveloping blank for machining one enveloping worm pinion.

FIG. 10 is a side view of a taped disc hob in mesh with an enveloping blank for machining one enveloping worm pinion.

FIG. 11 is an isometric view of a helical die in mesh with manufacturing enveloping worm having threads with less than one revolution.

FIG. 12 is a front view of a helical die in mesh with manufacturing enveloping worm having threads with less than one revolution.

FIG. 13 is an isometric view of two helical dies in mesh with manufacturing enveloping worm blank. The enveloping worms could be split in half after machining.

FIG. 14 is a front view of two helical dies in mesh with manufacturing enveloping worm blank. The enveloping worms could be split in half after machining.

FIG. 15 is an isometric view of a screw (strait worm) hob in mesh with manufacturing enveloping worm blank.

FIG. 16 is an isometric view of two screw (strait worms) dies in mesh with manufacturing enveloping worm blank.

FIG. 17 is a front view of a ball helical die (or hob) in mesh with manufacturing enveloping worm blank, where axes of rotation of worm blank and the helical die (or hob) are parallel.

FIG. 18 is a front view of a ball helical die (or hob) in mesh with manufacturing enveloping worm blank, where axes of rotation of worm blank and the helical die (or hob) are perpendicular.

FIG. 19 is a front view of a die (or hob) having concave shape along its axis of rotation in mesh with manufacturing enveloping worm blank.

FIG. 20 is a front view of a die (or hob) having convex shape along its axis of rotation in mesh with manufacturing enveloping worm blank.

FIG. 21 is an isometric view of a rotating tool having threads with less than one revolution in mesh with a face gear blank.

### DETAILED DESCRIPTION OF THE PREFERRED EMBODIMENTS

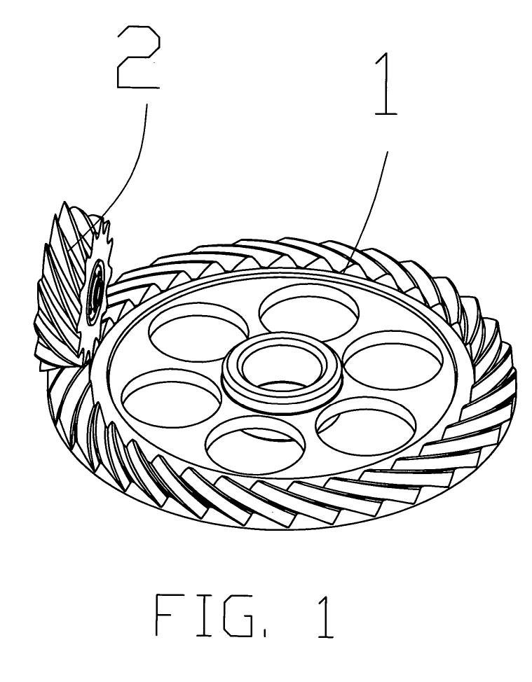

The following discussion relating to FIGS. 1-21 and provides a detailed description of the unique method for manufacturing enveloping worm and face gear that can be utilized with the present invention.

FIG. 1 is an isometric view of face gear 1 of an enveloping worm face gear transmission in mesh with enveloping worm 2 as a pinion. The enveloping worm face transmission is a new type of right angle gears (U.S. patent application Ser. No. 10/435,143). Said enveloping worm 2 has at least one thread that is engaged by at least one tooth of said face gear 1 wherein said enveloping worm 2 is placed into face arrangement with said face gear 1. In this enveloping worm face transmission the enveloping worm 2 could have any design, however, it is preferred that the enveloping worm is utilized for standard enveloping or double enveloping worm/worm gear transmission. The difference is that we are using threads with less than one revolution or 180 or less degree of revolution and even 90 or less degree of revolution. Degree of thread revolution means an angle of thread rotation around its axis of rotation.

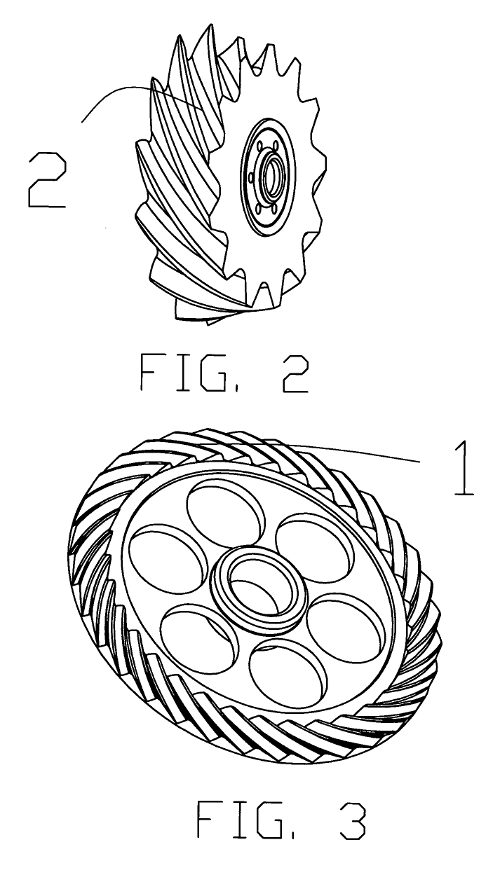

FIG. 2 is an isometric view of enveloping worm 2 where threads have less than 180 of revolution.

FIG. 3 is an isometric view of face gear 1.

Machining of enveloping pinion with less than one revolution of threads can be done by conventional hobbing, rolling (preferably cold) or grinding process with plunging feeding.

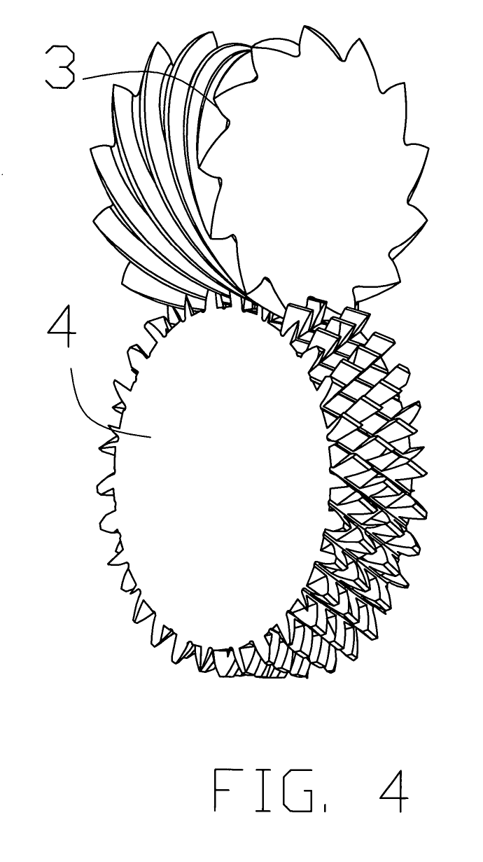

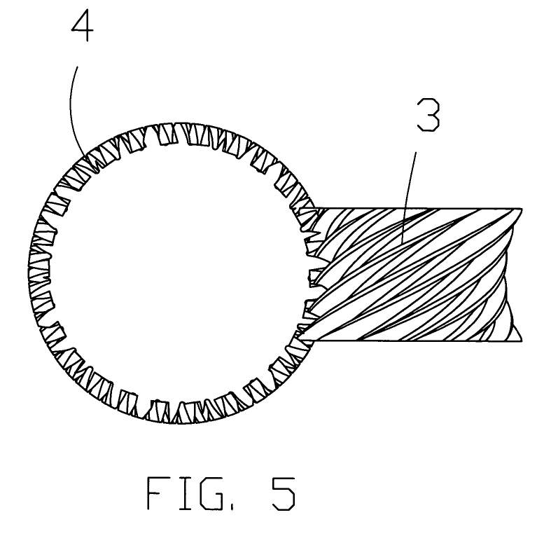

FIG. 4 is an isometric view of enveloping worm blank 3 in mesh with rotating hob 4 having helical form. Helical form hob could be with involute or straight side helical teeth. The teeth may be with symmetrical profile, but for same modifications they could be asymmetrical. FIG. 5 is a front view of enveloping worm blank 3 in mesh with rotating helical hob 4. Helical hob 4 could have form of helical gear. Enveloping worm blank 3 is being machined with plunging of rotating tool 4. Hob 4 rotates about its axis of rotation simultaneously with enveloping worm blank 3 and has feeding direction towards the axis of the rotating enveloping blank 3. Hob 4 rotates in ratio time faster than enveloping blank 3. After plunging the machined enveloping worm blank 3 it will be split into two halves. This makes two enveloping pinions at the same time. It is more technological to machine enveloping worm blank, then heat treat it, finished it and then split it into two halves.

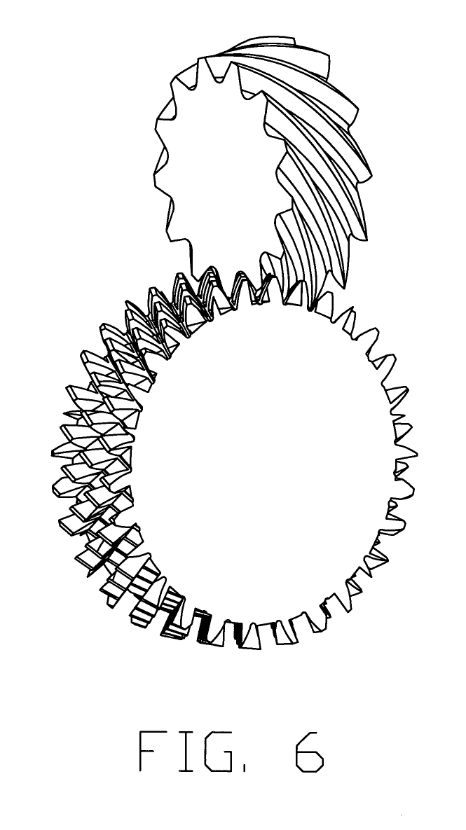

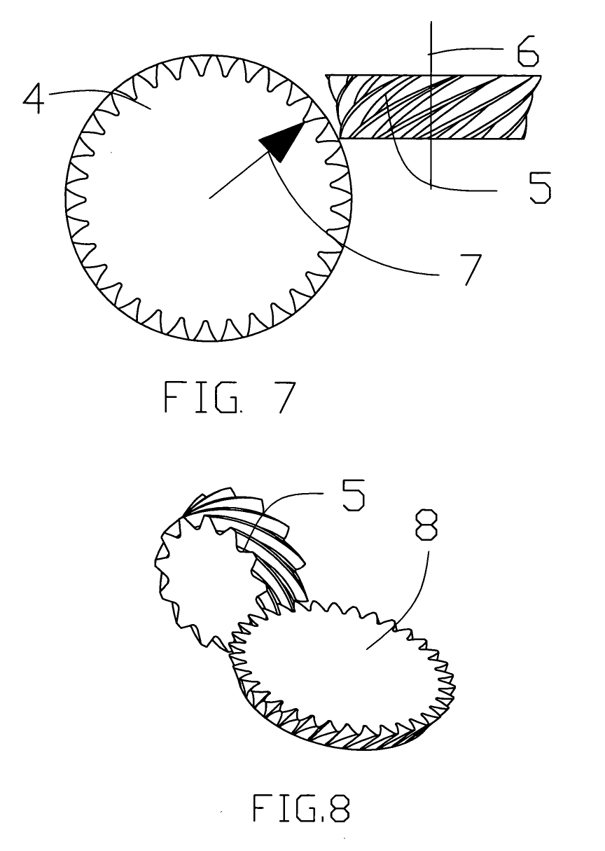

FIG. 6 is an isometric view of enveloping worm blank 5 in mesh with rotating hob 4. This blank has asymmetrical profile. Machining with plunging could be done the same way as was described for FIGS. 4 and 5. For enveloping worm face gears with bigger enveloping angle when they have lower ratios than 2.5:1 and less than 24 face gear teeth, plunging could shrink enveloping worm pinion's active thread length and reduces contact ratio. In this case machining of enveloping pinion could be done with preliminary feeding in angular direction, with an angle less than 90 degree between axis 6 of rotation of said enveloping worm blank 5 and direction of feeding for preliminary cutting. Arrow 7 is direction of preliminary feeding. The position of cutting tool 4 for preliminary cutting is shown on FIG. 7. After preliminary cutting, rotating tool makes additional turning into desirable position for plunging. Preliminary cutting avoids undesirable cuts of enveloping thread's ends. The feeding during preliminary cutting has a very small displacement where direction and amount could be defined on a computer model or practically on the real part by feeding hob into real enveloping pinion profile until it will touch the threads. Rotation into desired position will proceed until cutting tool 4 is positioned for plunging toward the axis of rotation 6 of enveloping blank 5.

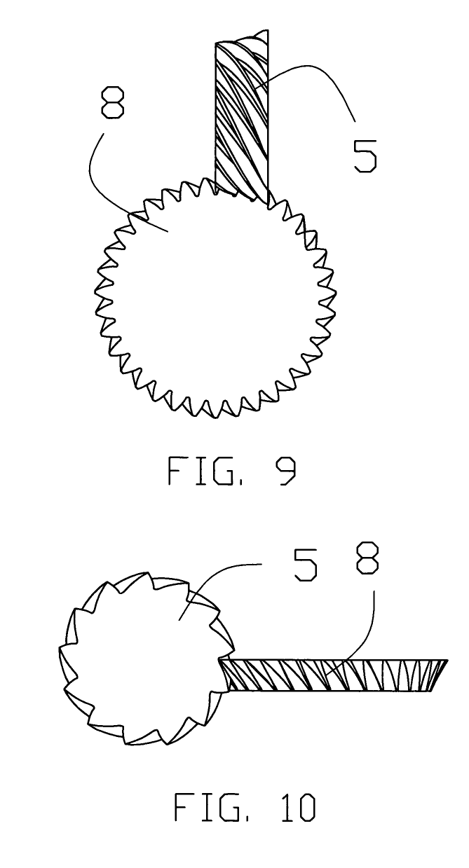

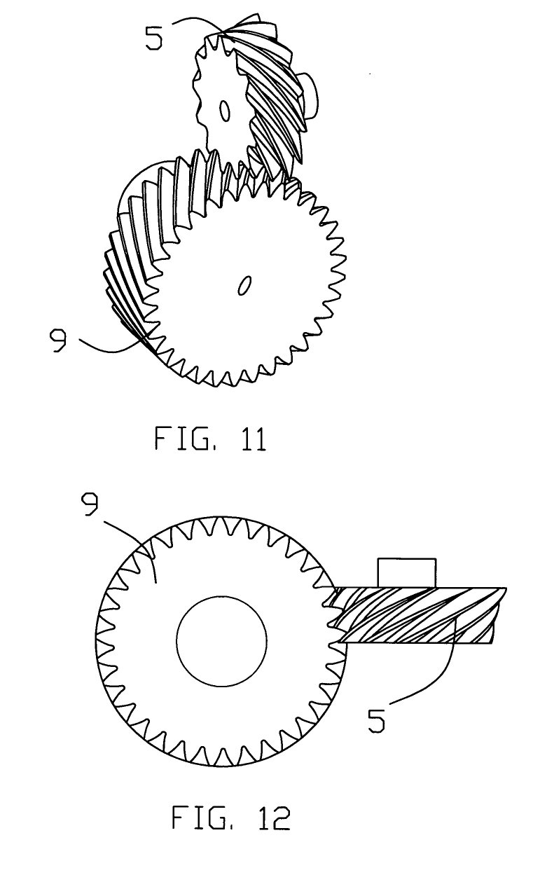

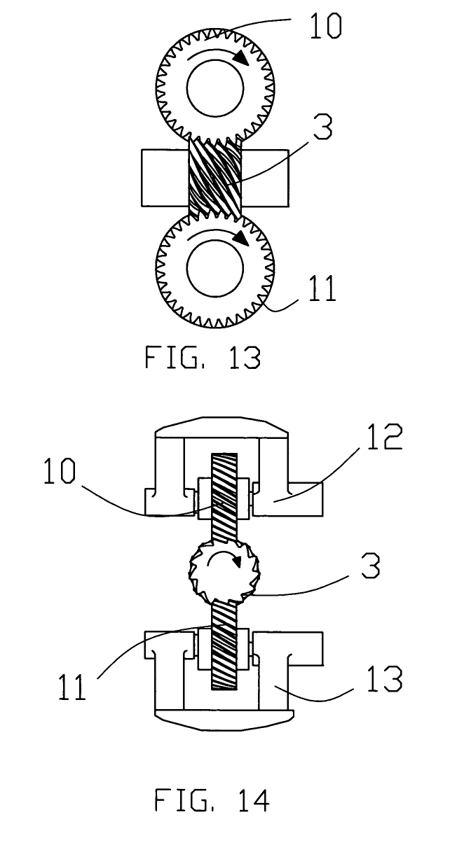

FIG. 8, FIG. 9 and FIG. 10 shows a set up for machining of enveloping worm blank 5 by taped disc hob 8. Manufacturing by plunging could be the same as was described for FIGS. 4 and 5. If it is necessary preliminary machining could be with the following turning of hob 8 and then final plunging. Same principal of plunging rotating tool into enveloping worm blank could be done by using rolling die. It could be manufactured using conventional roll (cold roll) manufacturing techniques. This can be done by one helical die 9 according with FIG. 11 and FIG. 12 or more preferably by opposite pressure from two rotating dies 10 and 11 in FIG. 13 and FIG. 14.

Arrows show directions of dies and enveloping blank rotations. Die 10 is located in upper support 12 and die 11 is located in lower support 13. The enveloping worm could be split into two halves after rolling.

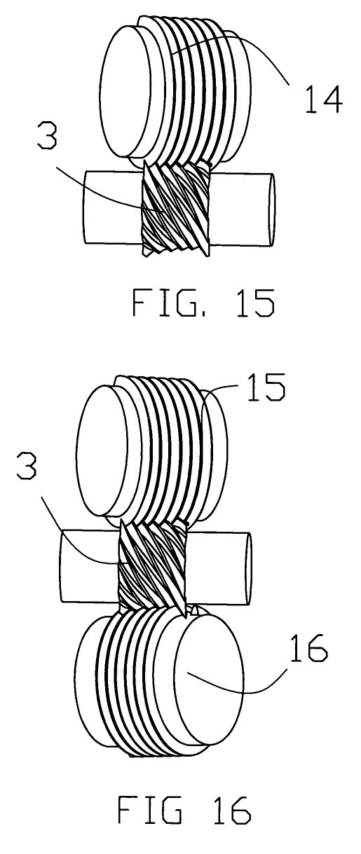

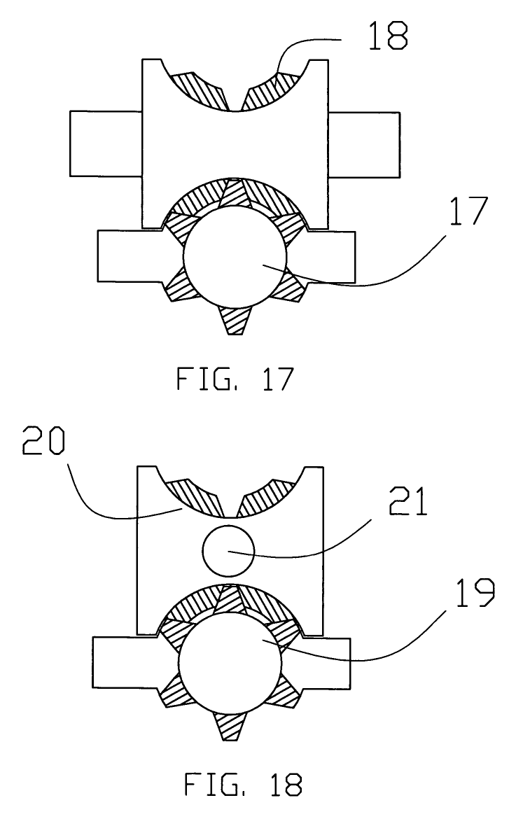

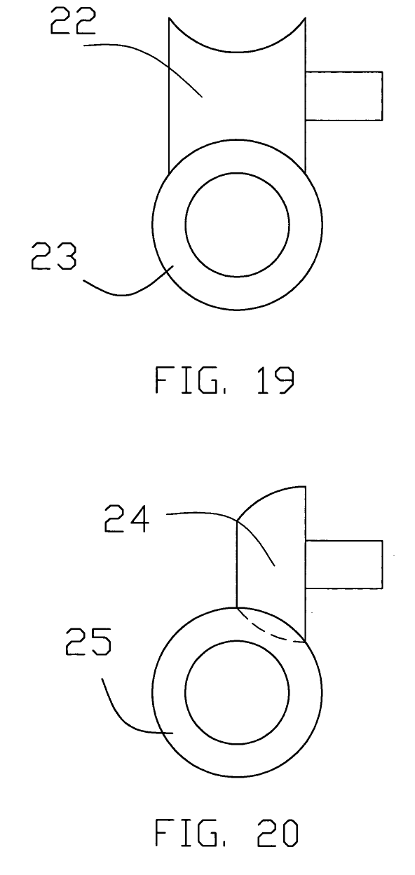

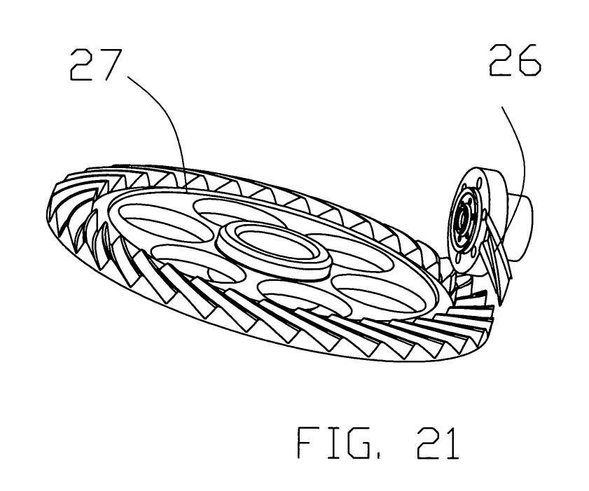

Cutting tool for machining with plunge feeding can be screw or straight worm form. It could be hobbing or rolling tool. Examples of using these rotating tools are shown in FIG. 15 and FIG. 16. It can be worm hob 14 or screw dies 15 and 16. For hobbing or rolling machining, the cutting teeth of the tool are positioned tangentially in a helical path of enveloping worm. For different modifications of enveloping worm pinion with less than one revolution of threads, when machining with plunge feeding the shape of rotating tool may be different. FIG. 17, FIG. 18, FIG. 19 and FIG. 20 show a variety of rotating tools having different shape profile along its axis of rotation. Ball shape of rotating tool 17 with rotating shaft can make machining with plunging of enveloping blank 18 with different angle between axis of tool rotation and axis of enveloping worm blank rotation. FIG. 17 shows that rotating shaft of enveloping worm blank 17 is parallel to rotation shaft of rotating tool 18. FIG. 18 shows that rotating shaft of rotating tool 19 is perpendicular to rotation shaft 21 of worm blank 20. New technology allows the making of rotating tool from abrasive material. Such tool can be used for rough cutting and for finishing by plunging feeding. Concave shape of rotating tool 22 in mesh with enveloping worm blank 23 in FIG. 19 can be parabolic or hyperboloid. Convex shape of rotating tool 24 in mesh with enveloping worm blank 25 in FIG. 29 can be parabolic or hyperboloid.

Manufacturing of face worm gear can be done by using rotating tool having shape of mating enveloping pinion with 180 degree or less of thread revolution. Rotating tool can have 90 degree or less of thread revolution. Rotating tool can have even one thread in order to be able to manufacture face gear. Machining can be done by conventional hobbing, rolling (preferably cold) or grinding process with plunging feeding. Direction for plunging is the shortest distance from initial position of rotating tool to machining face gear blank. The initial position can be defined by reverse engineering: moving mating pinion from mesh position in direction parallel to axis of face gear rotation or in direction perpendicular to the bottom of the surface located between face gear teeth, until there is no possible interference while mating pinion is spinning. FIG. 21 can be used for illustration of relation between rotating tool 26 with one cutting thread and face gear blank 27.

Above described method of manufacturing enveloping worm face gears makes face gear less expensive in production than any current technology. More efficient motion of enveloping worm face gears and ultra high torque capacity and lower production cost makes these new gears very competitive against known face, spiral bevel and hypoid gears.

In the invention being thus described, it is obvious that the same may be varied in many ways. Such variations are not to be regarded as a departure from the spirit and scope of the invention, and all such modifications as would be obvious to one skilled in the art are intended to be included within the scope of the following claims.

1. Manufacturing for face gears having an enveloping pinion in a mesh engagement with a face gear where said enveloping pinion has less than one revolution of threads is being machined with plunging of rotating tool into an enveloping worm blank.

2. Manufacturing for face gears as recited in claim 1 where enveloping pinion has 180 degree or less of thread revolution.

3. Manufacturing for face gears as recited in claim 2 where after plunging, machined enveloping worm blank is split into two pinions.

4. Manufacturing for face gears as recited in claim 1 where enveloping pinion has 90 degree or less of thread revolution.

5. Manufacturing for face gears as recited in claim 1 where during machining, said rotating tool has preliminary feeding in angular direction to axis of rotation of said enveloping worm blank followed by additional turning into desirable position for plunging.

6. Manufacturing for face gears as recited in claim 1 where said rotating tool has a helical form.

7. Manufacturing for face gears according with claim 1 where said rotating tool has a screw form.

8. Manufacturing for face gears according with claim 1 where machining is hobbing and said rotating tool is a hob.

9. Manufacturing for face gears according with claim 1 where machining is rolling and said rotating tool is a roll die.

10. Manufacturing for face gears according with claim 1 where said rotating tool is an abrasive tool.

11. Manufacturing for face gears according with claim 1 where said rotating tool has cylindrical shape along its axis of rotation.

12. Manufacturing for face gears according with claim 1 where said rotating tool has convex shape along its axis of rotation.

13. Manufacturing for face gears according with claim 1 where said rotating tool has concave shape along its axis of rotation.

14. Manufacturing for face gears according with claim 1 where said rotating tool has ball shape.

15. Manufacturing for face gears according with claim 1 where said rotating tool has parabolic shape along its axis of rotation.

16. Manufacturing for face gears according with claim 1 where said rotating tool has taped shape along its axis of rotation.

17. Manufacturing for face gears having an enveloping pinion in mesh engagement with a face gear where said face gear is being machined with plunging of rotating tool having form of said enveloping pinion with 180 degree or less thread revolution.

18. Manufacturing for face gears according with claim 17 where said enveloping pinion has 90 degree or less thread revolution.

19. Manufacturing for face gears according with claim 17 where machining is hobbing and said rotating tool is a hob.

20. Manufacturing for face gears according with claim 17 where machining is rolling and said rotating tool is a roll die.
